(19) United States
(12) Patent Application Publication
(10) Pub. No.: US 2020/0410893 A1
(43) Pub. Date: Dec. 31, 2020

(54) WEARABLE POSITION TRAINING SYSTEM

(71) Applicant: RideQ AB, SOLLEBRUNN (SE)

(72) Inventor: Annika RIDINGTON, Sollebrunn (SE)

(21) Appl. No.: 16/975,363

(22) PCT Filed: Feb. 13, 2019
(86) PCT No.: PCT/EP2019/053597

§ 371 Date: Aug. 24, 2020

(30) Foreign Application Priority Data
Feb. 22, 2018 (GB) 1802904.1

(51) Int. Cl. G09B 19/00; A63B 24/00; A63B 71/06

(52) U.S. Cl. CPC G09B 19/003; G06F 3/04847; A63B 71/0619; A63B 24/0062

(57) ABSTRACT

A wearable system for correction of body position, the system includes: a position sensor, configured to detect a position of a user's body part, and to transmit a position signal corresponding to the detected position; a processor, configured to receive the position signal, and to determine a deviation of the detected position from a predetermined optimal position; and a tactile feedback unit, configured to generate a tactile output in response to a determination that the detected position deviates from the optimal position by equal to or more than a threshold deviation. A method of correcting a user's body position includes the steps of: detecting, by a position sensor, the position of a body part of a user; transmitting a signal corresponding to the detected position; determining, by a processor, a deviation of the detected position from a predetermined optimal position; and generating, by a tactile feedback unit, a tactile output in response to a determination that the detected position deviates from the optimal position by equal to or more than a threshold deviation.

### TECHNICAL FIELD OF THE INVENTION

The present invention relates to a wearable system for correction of the position of a given body part(s), and a method of using the same.

### BACKGROUND TO THE INVENTION

Most people have a very low body awareness and all of us have a personal movement pattern. These are two reasons why it is hard to learn specific desired positions that are required in for instance in sports, work positions or rehabilitation, or when driving or operating a motorcycle or other motor vehicle. In some areas it is of great importance though to learn the required position or movement pattern to avoid injuries or achieve a highly skilled performance.

When horse riding, for instance, the foundation of the sport lies in that the rider is able to remain in balance at all times, for a number of reasons. The most obvious is the safety risk. If you are unbalanced you may fall of the horse. However, there are several other reasons. The rider communicates with the horse with body signals and movements. As soon as the rider is unbalanced it is easy to move unintentionally and give unintended signals when aiming to regain their balance that the horse might misinterpret. If the rider is not in balance the horse has to balance the rider as well as itself—which has the effect that it is much harder to perform. The risk of injuries increase because of strain related overloads of parts of the body, both for the horse and the rider. Similar arguments can be made in other sports, working positions or to rehabilitate as mentioned above.

To retain their balance when riding, horse riders train and perfect a position known as “the vertical seat”. It is one of the cornerstones of equestrian sports. However, because most people have a personal movement pattern and low body awareness, it is extremely hard to correct one's own position. One tends to fall back into what one is used to and to what one feels comfortable with. It is only when you have someone watching and training you on how to correct your body position that you are able to correct yourself.

Often, when a rider returns to riding alone, the tendency is for him/her to fall into the habitual movement pattern. To make a lasting change that is implemented in the muscle memory it is necessary to practice consistently the new desired position for a long period of time. It is sometimes said that over 10,000 repetitions of the new position are required.

Up until now, it has been difficult, if not impossible, to bridge the gap between what we ourselves perceive to be right, and what is actually right, without input from a second person. The present invention aims to address this problem.

### SUMMARY OF THE INVENTION

Broadly speaking, the present invention provides a system of digital aids which allows a user, such as but not limited to a horse rider to improve and perfect a desired body position effectively, using reinforced learning. The invention includes units for attachment to various parts of the body or sewn into a garment which are configured to provide real-time intuitive feedback when the user's body position deviates from an optimal position. Specifically, the present invention provides a wearable system for correction of body position, the system including:
a sensor, configured to detect a position of a user's body part or a movement pattern of a user's body part, and to transmit a signal corresponding to the detected position or detected movement pattern;
a processor, configured to receive the signal, and to determine a deviation of the detected position from a predetermined optimal position, or the deviation of the detected movement pattern from a predetermined optimal movement pattern; and
a tactile feedback unit, configured to generate a tactile output in response to a determination that the detected position deviates from the optimal position or optimal movement pattern by equal to or more than a threshold deviation.

Many sports and other activities require the athlete to use a lot of their cognitive capacity to be able to perform effectively. It has been found that of the three senses of hearing, sight and touch, the touch channel is the least used during sporting or other activities. This means that the tactile output is the least distracting for the user when used while performing the activity. Throughout this application, “position” and “movement pattern” data are stated as alternative modes of operation. However, it should be stressed that this application also covers the situation where the system is able to operate in either mode of operation, even if only one at a time (the “and/or” case), and also in both modes of operation simultaneously (the “and” case).

For more thorough results, in some embodiments of the invention the sensor is configured to a sensor, configured to detect a position of a user's body part and a movement pattern of a user's body part, and to transmit a signal corresponding to the detected position and detected movement pattern. Additionally, the processor may be configured to receive the signal, and to determine a deviation of either the detected position from a predetermined optimal position, and the deviation of the detected movement pattern from a predetermined optimal movement pattern. Additionally, the tactile feedback unit may be configured to generate a tactile output in response to a determination that the detected position deviates from the optimal position and optimal movement pattern by equal to or more than a threshold deviation.

The system may also include a power supply such as a battery, or the like, for supplying power to one or more of the position sensor, the processor and the tactile feedback unit. In other embodiments, the system may include means for connecting to a power supply, while not including the power supply itself. For example, the system may include a compartment for receiving one or more batteries.

Herein, the term “position” should be understood to refer to the orientation and/or location in space of the body part in question.

The sensor is preferably wearable, and accordingly, it may include an attachment means for attaching to the body part in question. In some embodiments, the sensor may be a position sensor which is able to detect the position of the body part based on its (i.e. the position sensor's) own position. The sensor may include one or more of an accelerometer, a gyroscope and a magnetometer, each of which is configured to detect the position or movement pattern of an object. In preferred embodiments, the sensor may include a gyroscope for detecting the orientation of the body part (i.e. the body part's rotational position in space), and an accelerometer for detecting the location or movement through space of the body part (i.e. the body part's translational position in space). In preferred embodiments, the position sensor is configured to continuously monitor the position or movement pattern of the user's body part. In such embodiments, the signal is transmitted continuously to the processor. In other embodiments the sensor may be configured to detect the position or movement pattern of the user's body part at predetermined intervals. The intervals may be no more than 1 second, no more than 0.5 seconds, no more than 0.25 seconds, and preferable no more than 0.1 seconds.

In preferred embodiments, the sensors are configured to self-calibrate each time they are turned on, in order to ensure that they have established a correct absolute value. The self-calibration process may take place as follows: a user holds the position which they perceive to be optimal when the system is first turned on, or place the sensor in a stable location while they execute what they believe to be an optimal movement pattern. This value or optimal movement pattern may then be set as a starting point (effectively a zero point). By calibrating in this manner, rather than having e.g. a pre-set starting point, variations between different users or different placements of the sensors on the body will not negatively affect the feedback. In preferred embodiments, this starting point is the “optimal position” or “optimal movement pattern” referred to throughout this application. In some embodiments, the tactile feedback unit is configured to generate a tactile output when the self-calibration has taken place, in order to inform the user that the process is complete.

In other embodiments, the sensor may not be wearable, and instead may include a camera which is configured to determine the position or movement pattern of the user's body part when it is in the field of view. In such embodiments, the processor preferably includes an image processing module configured to determine the position or movement pattern of the body part in question from an image signal generated by the camera and received at the processor.

The attachment means discussed in the previous paragraphs may be in the form of one or more of the following: a strap, a clip, an adhesive, a fastener, a button, Velcro®, or specially designed fastening solution. The skilled person is well aware that other alternative attachment means may be used.

In some embodiments, the processor may be configured to generate a deviation signal on determining that the detected position or detected movement pattern deviates from the optimal position or the optimal movement pattern by equal to or more than a threshold deviation. The processor is configured arranged to transmit the deviation signal to the tactile feedback unit, which is in turn configured to receive the deviation signal. The tactile feedback unit is preferably configured to generate the tactile output in response to receiving the deviation signal.

In some embodiments, the sensor, the processor and the tactile feedback unit may be located within a single component. In such embodiments, the sensor, the processor and the tactile feedback unit are preferably contained inside a single housing. In those embodiments, the connections between the sensor, the processor and the tactile feedback unit may be wired connections or wireless connections (the nature of the wireless connections is discussed in more depth later on in the application). The housing may be in the form of a hard, i.e. rigid shell, preferably a plastic shell. In other embodiments, the housing may in the form of a soft, e.g. bendable and/or flexible shell, which may be made of e.g. fabric, silicone, plastic or the like. In some embodiments, the system may include a garment, and one or more of the sensor, the processor, the single component, and the tactile feedback unit may be attached to the garment. For example, in some embodiments, the feature in question may be sewn into the garment. The garment may include trousers (e.g. jodhpurs for equestrian application), a jacket, a shirt, shoes, shoe inlays, gloves or the like.

In other preferred embodiments, the processor may be a separate component. In particular, the processor may be contained in an external computer device such as one of the following: a mobile phone, a smart phone, a tablet, a desktop computer or a laptop computer. In those embodiments, the position sensor is preferably configured to transmit the position signal to the processor wirelessly, and the processor is preferably configured to transmit the deviation signal to the tactile feedback unit wirelessly.

The tactile output of the tactile feedback unit is preferably in the form of a vibration. Accordingly, the tactile feedback unit may include one or more vibrators, arranged to vibrate in response to receiving the deviation signal. It is of course preferred that the system is configured to operate in real time. In other words, it is preferred that the tactile feedback unit is configured to generate the tactile output no more than 10 ms. More preferably, the delay is no more than 5 ms, and more preferably still no more than 2 ms. Most preferably, the delay is no more than 1 ms, after a determination by the processor that the deviation has exceeded the threshold. In some embodiments, the strength or intensity of the tactile output varies depending on the extent of the deviation. In some embodiments, on receiving the deviation signal, the tactile output may be immediate and strong. In other embodiments, the tactile output may begin immediately and increase in intensity until the user corrects their position to be within the predetermined deviation threshold. In other embodiments, the tactile output may be in the form of a series of bursts of vibrations, wherein the number of bursts or the delay between each burst may vary with the extent of the deviation. Preferably, the user is able to select the form of the tactile output in order to match their preferences. Broadly speaking, it may be said that it is preferred that the tactile output varies with the extent of the deviation.

In other embodiments, the tactile output may be in the form of an application of pressure to the body part in question. Alternatively, the tactile output may be in the form of a gentle electric shock.

The next feature of the invention is explained in the context of the “vertical seat” position used in horse riding, but it should be stressed that the feature is not limited to this application, as will be readily apparent to the skilled person. When a rider is riding a horse, aiming to improve their body position, it is likely that their body position or movement pattern will deviate from the optimal position or movement pattern relatively frequently. This means that frequent tactile outputs being applied to the body part in question will likely become irritating. Furthermore, it is difficult for a rider to concentrate both on riding (e.g. balance and control of the horse) as well as making the correct adjustment to the position or movement pattern of the body part which is being trained. For that reason, the tactile feedback units of the present invention are preferably configured to provide the tactile output to locations in the body where the response is intuitive. In other words, the tactile output is preferably configured to elicit an intuitive response by the user. By “intuitive”, this means that the user does not have to think consciously about the response, rather it is reflexive. The user reacts, in a gentle manner, instead of having to act.

A number of specific points on the body have been identified by the inventors, where an intuitive response in the desired direction can be obtained.

One such example is a human's tendency to look down, when they should be looking up, focusing and facing forward. This is important in a huge variety of activities and is especially problematic in horse riding, in which a common fault is to look down and focus on the hands, or the front of the horse, instead of focusing on where you are going. Doing so can affect the balance of the whole body, which can then cause other body parts also to move in an undesirable way. So with this in mind, it is particularly preferable that the body part in question is the head.

The inventors have found that by influencing a point under the chin with a tactile output, that the user will reflexively life their gaze and face forward, and also raise the head to a level or other angle position if necessary. In order to avoid irritating the user, the tactile output is preferably applied to the chin itself, and not too far back towards the throat. Accordingly, the tactile feedback unit is preferably configured to provide the tactile output to the chin of a user. For example, the tactile feedback unit may include means for attachment to a user's chin, such as a strap or an adhesive or the like.

In addition to this, in order to correct the movement of a user's whole head forward, pushing the chin out, i.e. to cause a user to pull their head back and tuck their chin in, the tactile feedback unit is preferably configured to provide the tactile output to the base of the back of the head of the user. Again, for example, the tactile feedback unit may include means for attachment to a user's chin, such as a strap or an adhesive or the like.

In order to correct a user's slouching with their upper body and chest, the tactile feedback unit is preferably configured to provide the tactile output to an area of the chest covering the breastbone. Such a tactile stimulation entices the user to lift the upper-chest without the tendency to arch and tense their back while correcting themselves. This arrangement is also advantageous in that it can have a side-effect of causing the user to position their arms and elbows closer to their body when e.g. riding.

In order to correct a shoulder that has fallen forward (which is usually the same shoulder as the handedness of the user), the tactile feedback unit is preferably configured to provide the tactile output to the front of that shoulder.

It is common for e.g. horse riders to twist their hands in undesirable ways. The desired position in the context of horse riding is for the hand to rest with the thumb on top, where the hand is not cocked and the line from the elbow to the hand is not broken/straight. In order to correct faults along these lines, the tactile feedback unit is preferably configured to provide the tactile output to a point inside the hand, on the muscle connected to the thumb.

As will be apparent from the above description, there are a number of body parts to which the tactile output may be advantageously provided. Accordingly, preferred embodiments of the system of the present invention may include a plurality of sensors, and corresponding plurality of tactile feedback units, each of which may have the optional features referred to above and elsewhere in this application. In some embodiments, each pair of sensor and tactile feedback unit may have an associated processor. However, in preferred embodiments, each of the plurality of sensors is configured to transmit a respective signal to a single processor, and a single processor is configured to transmit a deviation signal to each of the plurality of tactile feedback units.

The tactile feedback unit may be configured to provide the tactile output to one or more of: the base of the chin, the base of the back of the head, the area of chest covering the backbone, the front of the shoulder, between the shoulder blades, the outside of the elbow, above the waist, above the navel, or the inside of the hand

In some embodiments of the invention, the system may include a plurality of modules, each including a sensor and a tactile feedback unit, preferably within the same housing. There may be one processor in the system which is located in one of the modules, which may be referred to as the master module. In preferred embodiments, the plurality of modules are all configured to communicate with each other wirelessly, such as via Bluetooth. The master module may be configured to collect position data from the sensors present in the other modules.

It should be noted that in embodiments including a plurality of sensors, each of the sensors has a respective optimal position or an optimal movement pattern, and an associated respective threshold deviation. The reason for this is that clearly a sensor which is configured e.g. to determine the position or movement pattern of the user's head will have a different optimal position or movement pattern from a sensor which is configured e.g. to determine the position or movement pattern of the user's hand. Similarly, there may be different amounts of acceptable deviation associated with different body parts.

In some embodiments, the modules or sensors may be configured to have an order of priority, wherein when a given module or sensor is active (i.e. giving feedback to the user), the remaining modules/position sensors/tactile feedback units are inactive. This provides the opportunity for a user to work on the position of one body part in particular at a time. In such embodiments, the remaining modules/sensors/tactile feedback units may be manually activated by the user, or by another person. Alternatively, the remaining modules/sensors/tactile feedback units may be configured to become active after a predetermined amount of time. In some embodiments, the amount of time will be 30 seconds or more. In other embodiments the time may be 1 to 30 seconds. However, the predetermined amount of time is adjustable by a user, perhaps based on their skill level. In some embodiments, the processor may be configured to adjust the predetermined amount of time based on data recorded by the sensors.

So that a second person is able to control the system while it is in use by a user, it is preferably remote-controlled, e.g. using a tablet or smartphone.

In addition to sensors, some embodiments of the present invention may include one or more pressure sensors or force sensors. In embodiments in which the seated posture of a user is to be corrected, the pressure sensor or force sensor is preferably configured to detect the pressure or force distribution of the user over an area, and to transmit a pressure or force signal to the processor. Accordingly, the system may further include a stirrup, stirrup leather, seat, saddle, saddle mat, mat or the like, the pressure sensor or force sensor being located therein. In other embodiments, as discussed earlier, the system may include a garment such as trousers, a jacket, a shirt, shoes, shoe inlays, gloves or the like, in which the pressure sensor or force sensor is located or a specially designed feature made of e.g. plastic, silicone, thermoplastic elastomer, or some kind of fabric. Preferably the pressure sensor is located in trousers, and in particular in the seat of the trousers, so that it can detect the pressure distribution as the user sits down. Alternatively, the pressure sensor may be located in between the saddle, leg, thigh or foot, and the horse, e.g. in a layer of material. In some embodiments, a force sensor may be located between a stirrup and a stirrup leather in order to establish that the right amount of force is applied to the stirrup during riding. In such embodiments, the force sensor is preferably configured to measure an extension force.

In embodiments including a pressure sensor, the processor may be arranged to determine the deviation signal based on a combination of the position signal and the pressure signal. This may be used to correct pelvis position, thigh position, foot position, upper-body position or hand position. For example, the tactile feedback unit may be configured to provide the tactile output to various points around the hips and waist, based on the pressure distribution for pelvis positioning. It should be stressed that the tactile output need not be applied to the points on the body where the deviation takes place. Rather, the output should be applied to parts of the body, the adjustment of which can be used to address the measured deviation.

We refer above to an optimal position and a threshold deviation. In some embodiments, the threshold deviation may be predetermined, and fixed. However, in preferred embodiments, the threshold deviation may be adjustable by the user. Specifically, the system may include a computer system which is configured to receive an input from a user. In preferred embodiments, the computer system may have loaded thereon an application, which is configured to provide a user interface. The computer system is preferably configured to receive the input from the user via the user interface provided by the application. In some embodiments, the input may be to adjust the threshold deviation for a given position sensor. The user interface may include a sliding scale or a text box using which the desired threshold deviation may be selected or similar equivalent input means. It should be noted that the processor of the invention may be located on the computer system referred to in this paragraph. The computer system may be in the form of a smartphone, a tablet or a computer (e.g. a laptop). In other embodiments, the level of feedback or the threshold deviation may be adjusted or set automatically. For example, the system may be configured to collect position data or movement pattern data for a predetermined amount of time. The processor or some other external component may then be configured to determine how much and/or with what frequency the user deviates from a predetermined optimal position or movement pattern. Based on this information, the processor may determine the threshold deviation. In preferred embodiments of the present invention, the processor is configured to decrease the threshold deviation as the user's performance improves. Specifically, the processor may be configured to determine that the amount or frequency with which the user deviates from the predetermined optimal position or predetermined optimal movement pattern has decreased, and in response to determining the decrease, lower the threshold deviation. In this way, as a user's performance improves, the system will provide feedback to smaller deviations from the optimum over time, in order to further train the user.

Other features may be adjustable or controllable using the interface. For example, the predetermined amount of time for which the remaining modules/sensors/tactile feedback units are inactive may be adjustable using the user interface provided by the application. The user interface may also be configured to allow a user to activate or deactivate any of the sensors/modules/tactile feedback units in order to train only one or more body parts in particular.

In addition to providing real-time feedback to the user, the system may preferably also be configured to store data associated with the user. In order to do so, the system may further include a memory configured to store data. In some embodiments, the system may be configured to store position data, movement pattern data or pressure distribution data from the sensors on the memory. In particular, the system may be configured to store a record of the deviation from the optimal position or the deviation from the optimal movement pattern over time. The deviation may be calculated by the processor or processors. Doing so will allow the user to assess the change in deviation from the optimal position over time, in order to track their training process. In embodiments offering this feature, the application may also provide an interface allowing the user to view a graphical representation of the data. Data, preferably position, movement pattern or pressure data may be received at the memory from either the processor/processors or the master module, for example. In some embodiments, each of the sensors may be configured to transmit data to the memory. In embodiments in which the sensors are position sensors, the stored data may be used to determine the movement pattern data, which may then be used to determine deviation from a predetermined optimal movement pattern, i.e. in order to enable the movement pattern mode of operation.

In some embodiments, the processor may be arranged to combine the position and pressure data from all of the position and pressure sensors in order to generate a representation of the overall position of the user (i.e. the position of the user's entire body, rather than just the individual parts) which may then be displayed on the computer system via the user interface.

In addition to storing position, pressure distribution and/or deviation data so that it can be reviewed by the user, the system is also preferably configured to apply algorithms to that data in order to improve the quality of feedback (i.e. by the tactile feedback unit) which it provides to the user. Specifically, the system is preferably configured to utilize machine learning techniques in order to improve the quality of the feedback which it is able to provide. The use of machine learning enables the system to identify and label parameters specific to the activity.

In preferred embodiments, the tactile feedback unit is configured to generate a tactile output only when it is determined that the user is performing a selected activity. Specifically, the selected activity may have associated with it an activity model which defines the set of movements associated with that activity. The processor is preferably configured to compare data from the position and pressure sensors with the activity model in order to determine whether or not the data from the position and pressure sensors is consistent with the selected activity. In order to improve the activity model, and so to provide overall better feedback to the user, it is preferred that the processor is also configured to update the activity model based on the data from the position sensors. This represents a machine learning loop. The activity model is preferably stored and/or labelled on the memory.

The activity model may include data representing an optimal body position for the selected activity. Specifically, the data may correspond to an expected set of movements of the body part in question which are associated with the selected activity. The data may include position data (i.e. a combination of orientation and location, preferably in three dimensions), velocity data, pressure distribution data and/or acceleration data. For this reason, it is preferred that the position sensor include an accelerometer and a gyroscope.

When it is determined that the user is not performing the selected activity, the tactile feedback unit preferably does not generate a tactile output signal. This means that in situations e.g. before the user begins the activity, or if the user has an unexpected stop or fall, they do not receive feedback from the system. This is advantageous since it ensures that feedback is only provided when necessary, resulting in an overall more efficient system, with fewer “false positives”, that do not distract the user from the performance.

In preferred embodiments, the memory is located on the computer system. However, in some embodiments, memory may be a cloud-based memory or external server to which the processor is configured to transmit data.

The present invention may be used for correction of body position in a range of activities, in particular sports, working position and rehabilitation, or riding motorcycles or other motor vehicles. Examples of sports for which the present invention may be particularly useful include: American football, soccer, bicycling, mountain biking, downhill skiing, snowboarding, skiing, tennis, golf, gymnastics, and other sports in which a user's body position is particularly important.

Preferred embodiments of the present invention are for use in horse riding. In such embodiments, the system is preferably also configured to identify the gait of the horse. In other activities the system could be configured to identify a flexible parameter specific to the activity. Specifically in the horse riding embodiment, the system may be able to do so using data from the position sensor relating to the height of the sensor above the ground, duration over a time period and the velocity or speed of movement. Analogous to the activity model, each type of gait of the horse may have associated with it a gait model, which defines the set of movements associated with that gait. The processor is preferably configured to compare data from the position sensors with the gait models in order to determine with which gait the horse is moving, i.e. to see with which gait model the data from the position sensors is most consistent. In order to improve the gait model(s), it is preferred that the processor is configured to update the gait model based on the data from the position sensors. Again, this represents a machine learning loop. The gait model(s) is preferably stored on the memory. For other activities this concept model is replaced with one specific to the activity.

In addition to a system, a second aspect of the present invention provides a method of correcting a user's body position, the method including the steps of:
detecting, by a position sensor, the position of a body part of a user;
transmitting a signal corresponding to the detected position;
determining, by a processor, a deviation of the detected position from a predetermined optimal position; and
generating, by a tactile feedback unit, a tactile output in response to a determination that the detected position deviates from the optimal position by equal to or more than a threshold deviation.

The method of the second aspect of the invention is preferably performed by the system of the first aspect of the invention. Where compatible, optional features set out above with respect to the first aspect of the invention apply equally well to the second aspect of the invention. The skilled person is well-aware of which features are compatible.

Further optional features of the invention will be described below.

### BRIEF DESCRIPTION OF THE DRAWINGS

Embodiments of the invention will now be described in detail with references to the accompanying drawings, in which:

FIG. 1A shows a schematic overview of a system of the present invention.

FIGS. 2A to 2C show examples of the placement of various sensors and tactile feedback units according to the present invention.

FIGS. 3A to 3C illustrate some of the machine learning algorithms which may be performed according to the present invention.

FIG. 4 illustrates the z-direction movement associated with a variety of types of horse gait.

### DETAILED DESCRIPTION OF THE DRAWINGS

Broadly speaking, preferred embodiments of the invention are directed towards a wearable system for reinforced learning to immediately and intuitively adjust different body parts positioning to a desired position for different activities like sport, work positions or rehab purposes by delivering a tactile feedback on specific points. The system helps improve the muscle memory by inducing intuitive tactile feedback in real time. More specifically, the system is capable of providing intuitive feedback in real time on the body part that is to be corrected while performing an activity. The units are fastened directly on the body part they intend to influence and are able to communicate with each other. The system is optimized with the help of machine learning algorithms and the collected data to deliver a more and more optimized feedback for the user over time.

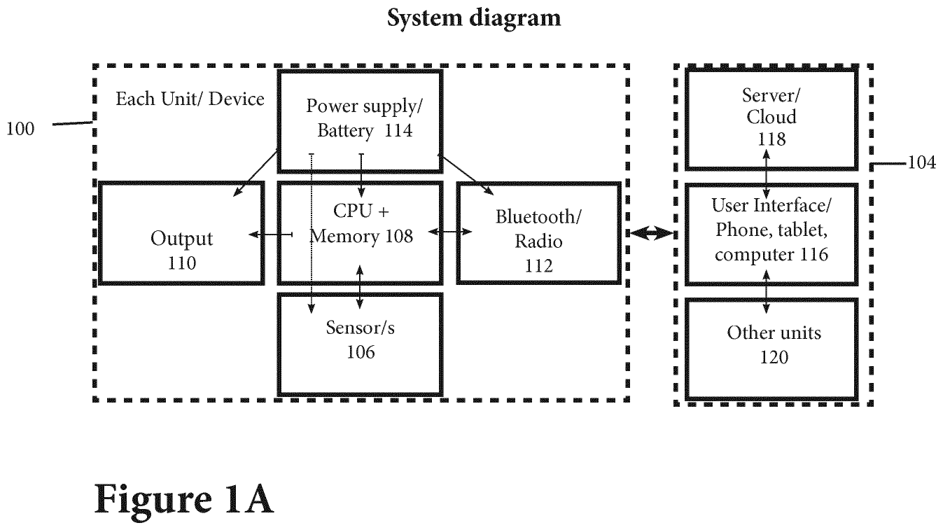

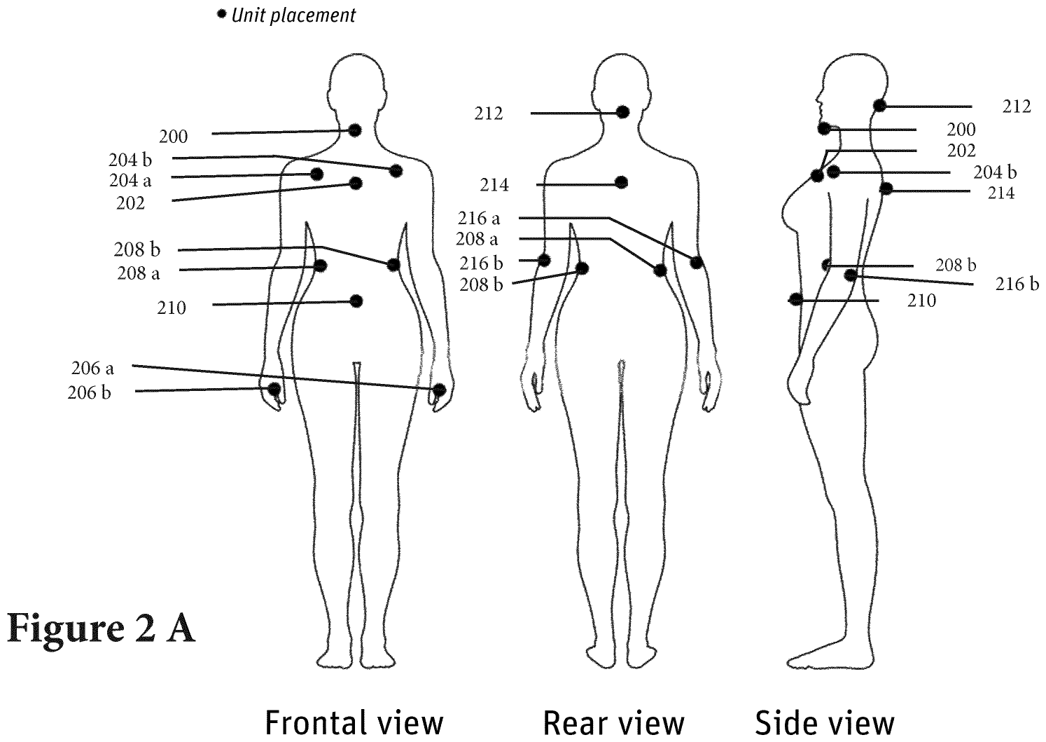

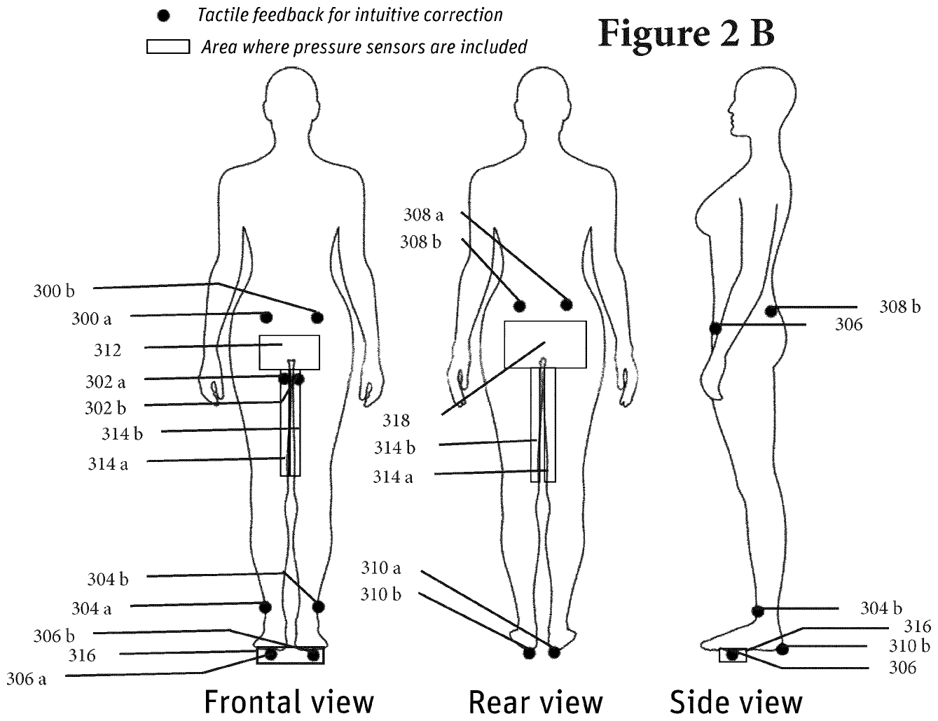

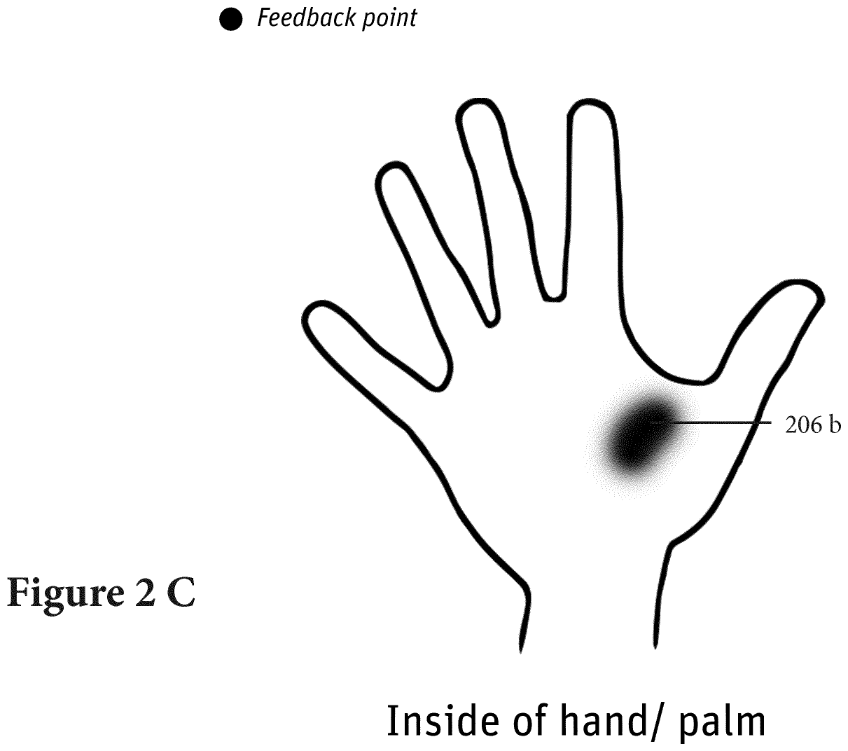

FIG. 1 shows a broad overview of the system 100 in one embodiment of the present invention. Broadly speaking, the system 100 is divided into two parts: the unit 102 and the external device 104. These will be discussed in turn below. The unit 102 includes sensor 106, CPU/memory module 108, output 110, wireless component 112, and power supply 114. The operation of the system 100 will now be described. Sensor 106 is a position sensor as discussed earlier on in the application. It is worn by, or attached to a user of the device (locations of the position sensors are discussed in more detail later on with reference to FIGS. 2A to 2C), and is configured to detect the position of the body part to which it is attached.

This may, for example, be the chin of a user. The sensor 106 may be self-calibrated before operation, as discussed earlier in the application. On detection of the user's position, the sensor 106 is configured to transmit a position signal to the CPU/memory module 108, which is equivalent to the processor as discussed earlier in the application. The CPU of the CPU/memory module 108 then determines the deviation in the user's position from a predetermined optimal position. In the event that the deviation is greater than a predetermined threshold deviation, the CPU/memory module 108 is configured to send a signal to the output 110, i.e. the tactile feedback unit. On receipt of that signal, the output 110 generates a tactile output, such as a vibration, to inform the user that they have deviated too far from an optimal position. The sensor 106, the CPU/memory module 108, and the output 110 all receive power from the power supply 114.

In addition to providing real-time feedback via the output 110, the system 100 is also configured to record and store data concerning a user's position as they use the system 100. To that end, the memory portion of the CPU/memory module 108 may store data from the position sensor 106. In preferred embodiments, the memory is a temporary store. The unit 102 includes a wireless component 112, which is able to transmit signals wirelessly, e.g. by Bluetooth or RF signals to the external device 104. Specifically, the external device 104 may include a user interface device 116, in the form of e.g. a phone, a tablet or a computer. Data stored in the memory of the CPU/memory module 108 of the unit 102 may be transmitted using the wireless unit 112 to the user interface device, from which it may then be transmitted by the user interface device 116 to an external server or cloud server 118 for permanent storage. The user interface device 116 may also connect to other units 120 identical to unit 102.

As described in more detail in the Summary section of this application, the user interface device 116 preferably has loaded on it an application which the user may use to adjust various parameters associated with the invention.

FIG. 2A shows frontal, rear and side views of possible locations in which units (i.e. a combination of position sensors 106 and tactile feedback units 112) may be placed on the user's body:
Sensor 200 is located under the user's chin. A tactile output applied here causes the user to intuitively lift their head.
Sensor 202 is located on the chest in the region of the breastbone. A tactile output here can be used to correct intuitively a user's slouching with their upper body and chest.
Sensors 204a, 204b are located at the front of the user's shoulders. A tactile output here is used to correct intuitively a shoulder that has fallen forward.
Sensors 206a, 206b are located on the user's hands, specifically in the location indicated in FIG. 2C. In doing so, undesirable twisting of the user's hands can be corrected intuitively, in order to ensure that the hand is in the optimum position, with the thumb on top.
Sensors 208a, 208b, 210 are located on the user's waist and stomach. These can be used to correct intuitively position of the user's waist, i.e. their seat position. Specifically, sensors 208a, 208b, on the sides of the body, in the area above the waist are used to compare symmetry and to detect whether the user might bend at the waist on one side, most riders do. Sensor 210, a few inches above the belly button is used to entice the user to engage the core, which stabilizes and balances the whole trunk).
Sensor 212 is located at the back of the user's head, and can be used to cause a user to intuitively pull their head back and tuck their chin in, in order to correct a position in which the head is too far forwards.
Sensor 214 is located in the user's upper back (and will entice the user to pull their shoulder blades back, in contrast to the ones in the front that lift the breastbone. More tension is usually caused by this feedback but in some cases it is preferred.
Sensors 216a, 216b are located at the outside of the user's elbows, to help the user position the elbows next to the body. Most riders have a tendency to stretch their arms forward, creating tension and stiffness in the movement of the arm and hand. In the correct position the arms should be bent at the elbow, placed naturally hanging down on the side of the body, and from the elbow to the horse's mouth should be a straight line. The signal to the horse is not mainly given by moving the arms around but mainly controlled with the tension of the muscles in the back. These will control the contact the rider has with the horse's mouth. If the arms are held in front of you or this line is broken you have to use your arms to change this pressure which is incorrect.)

By “intuitively” it should be understood that the user moves the relevant body part in the right direction to correct the perceived deficiency, and by the right amount.

The shades areas are representing areas where there are pressure sensors that will deliver an output in the shape of a pressure pattern or a specific value. This pattern is compared to an optimal pattern and the value is compared between the two sides, in most instances, but not always, the value should be similar on the two different sides.

The area 318 around the crotch and the backside, are the area where the pressure of the pelvis is measured when the rider is sitting in the saddle. Points 308a, 308b are where the tactile feedback is applied to inform the user to move the rotation of the pelvis forward or backward, or the weight of the body right or left to have an equal weight distribution.

The areas 314a, 314b, on the inside leg is the areas where the thigh encloses the horse. The correct value is when the weight is evenly spread over the whole area and has contact. It is easy that the rider loses contact on one leg or parts of the area and then feedback is given feedback at points 302a, 302b.

The area 316 under the ball of the foot is where the stirrup is placed and once again this should be evenly distributed over the area and similar on both sides, since the correct stance is very similar to a standing position. If it is not the user need to correct the legs position and/or the weight distribution between sides. The points 304a, 304b, 310a, 310b on the ankles and heels are areas where feedback is given to move the leg back or forward.

Inside the hand on the fingers next to the palm the pressure are compares the pressure between the two hands since in most instances, if you are not on a bent track, the pressure of both hands should be the same to have an even pressure of the bit in the horse's mouth. If it is not this with be signalled to the user in the feedback point inside the hand by a certain pattern, different from the rotation of the hand feedback.

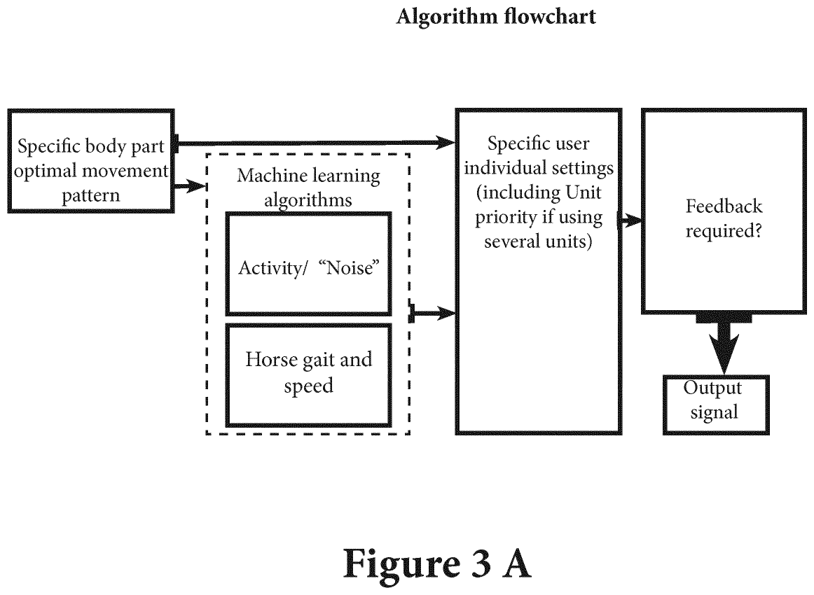

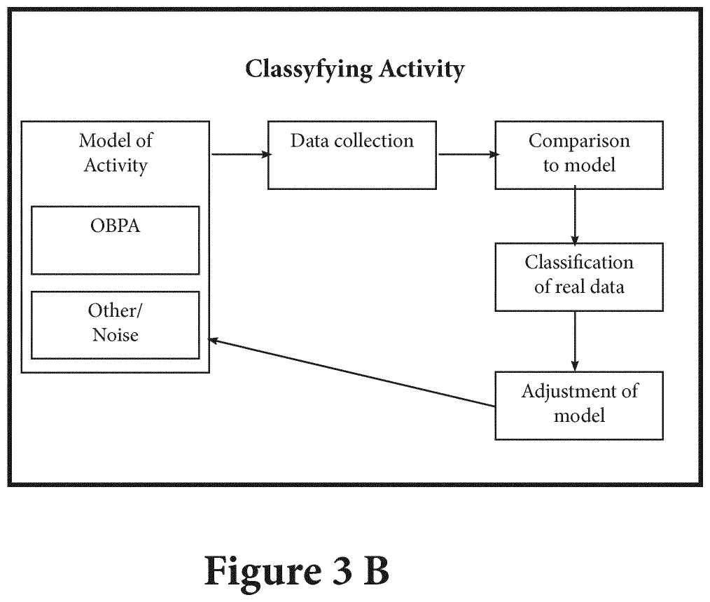

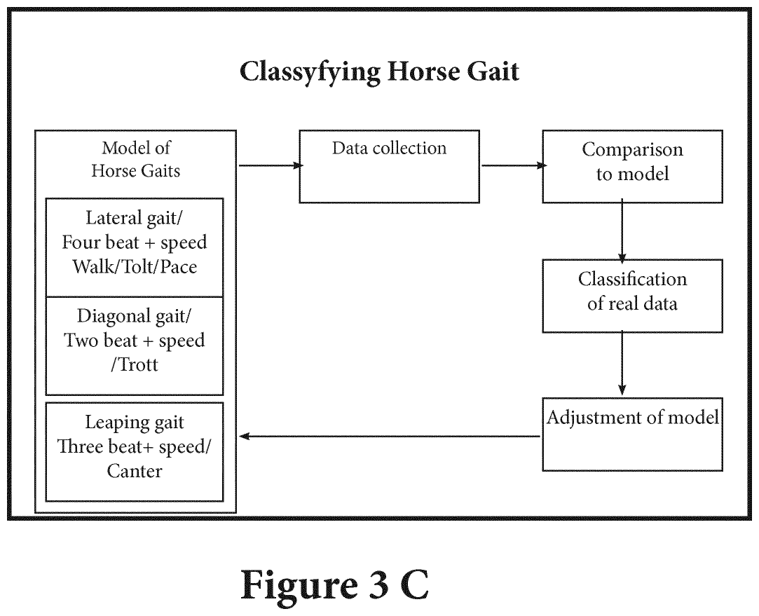

As is discussed earlier in this application, preferable embodiments of this invention are able to use machine learning techniques in order to improve the quality of the feedback which is given to a user when using the system 100. FIGS. 3A to 3C illustrate this process. The specific examples shown in these drawings are directed towards the use of the system by a horse rider, but the skilled person is well-aware that it may be used during other sports and activities, where the gait detection loop is replaced with one consistent with the specific parameters of said activity.

When a user first starts using the system, there are certain “out of the box” settings, i.e. default settings which are automatically in place. However, there is also an option for the user to create a specific account, which is assigned a prefix. Each time the user uses the device it gathers raw data that is stored under this prefix on a server or in the cloud (or temporarily on the device internal memory in CPU/memory unit 108). The prefix could be the user's name. In some embodiments, the prefix value could be the name of a specific horse. The same user might have several accounts if they have several horses. Each session the rider logs into their account all the raw data received by the position sensors (and/or pressure sensors in those embodiments which include them) is collected, and used to determine and classify patterns.

Algorithms are used in order to determine what movement is within the set of “desired movements” and what movements are undesired or “noise”. Here, “desired movements” refers to those movements which are associated with the activity in question, whereas “noise” represents those movements which are result from other events. The set of desired movements may be referred to as the optimal body pattern (OPB), which is a predetermined desired movement pattern for a specific body part for a given activity.

The OPB may be determined as follows: there is a “normal range” of movement for each body part movement when a given activity is performed. This normal range may be determined by position; i.e. by the position sensors, pressure distribution and over time. This normal range is determined by gathering raw data from a large number of expert users that have been performing the movement/activity while being filmed. Each deviation is supplied with a timestamp that has been used to create a model from the raw data of the normal range of this movement in terms of position and duration. Thus, an OBP may be determined for each body part.

Using an application on the user interface device 116, the user is able to control, adjust or “tweak” the OBP based on their individual preferences. The adjustment may take place based on one or more of the following criteria: skill level/acceptable deviation from optimal value, acceptable time delay, (acceptable duration for which the body part in question can deviate from the optimal position by equal to or greater than the threshold deviation), form of tactile output (strength, duration, intensity, pattern or and in some cases it may be turned off entirely, so the system is configured only to collect data), priority if using several units and time-delay in between signals from a plurality of units.

FIGS. 3B and 3C show two machine learning loops which the processor 108, or other component of the system 100 is configured to perform. By using these loops, it is possible to optimize when a tactile output signal should be delivered, and also to evolve the OBP for future iterations of the system. Specifically, the loops are used to:
Determine that a user is actually performing the intended activity, and so that feedback should be given.
Determine the gait of the horse in order to optimize the functioning of the system. In the case of other activity then horse riding this loop will be replaced by one with specific parameters for that activity.

FIG. 3B represents the first of these. Since the OBP of each body part for a given activity is predetermined, there exists already a predetermined range over which feedback can be delivered.

Data is collected to identify the user's and “other” movement patterns, to determine whether the activity is within the scope of the specified movement for the body part. This is done in order to allow the system to establish whether the user is engaged in the activity for which feedback is desired. Patterns over time may be identified, which will show when the user is performing an activity for which feedback is not required (i.e. in which they are not required to adopt the “vertical seat” position, discussed at the beginning of this application). Such activities may include: running, walking, standing still, talking, mounting the horse, bending down, falling off the horse, jumping an obstacle, riding over cavaletti, or the like

The raw data that is collected from each user is analysed by the system in order to identify repeating patterns in the data during the duration of each use. For example, the user may switch the system on, and select their preferred settings while standing still on the ground. There may or may not be a time delay before they mount the horse. What this “mounting” pattern looks like will clearly differ between users, however, there will be some similarities between the “mounting” patterns of all users. So, by collecting a large amount of data, it is possible to more clearly recognize, differentiate, and label movement patterns. This then means that adjustments can be made to the system based on the activity which is identified.

In another example, a rider may have fallen off the horse, and be lying still on the ground. Clearly, at this point, feedback about the rider's body position is not especially important.

So, the system will identify that the “activity” being performed is not within the scope of the “desired movements” and so no feedback will be given. In this specific case, the falling may be identified by the detection of a position other than “normal”, a sudden change of position, a sudden change of velocity and possibly a lack of movement altogether. This may cause the system to switch off, and not to give any feedback until, for example, it is detected that the user has mounted the horse again, and their movement pattern falls within the scope of the “desired movements”.

By collecting raw data related to position, acceleration and time, and comparing it to “normal” or OBP performance, the system is able to distinguish, recognize and acknowledge certain events in the user's movement pattern that are outside the scope of a specific activity (i.e. one for which feedback is required/desired). The main use of this feature is to distinguish between situations in which feedback is desired, and situations in which feedback is not desired, thus optimizing the performance of the system. Another advantage provided by this is the detection and labelling of activities that can be used to improve the OBP for this and other activities and the system in general.

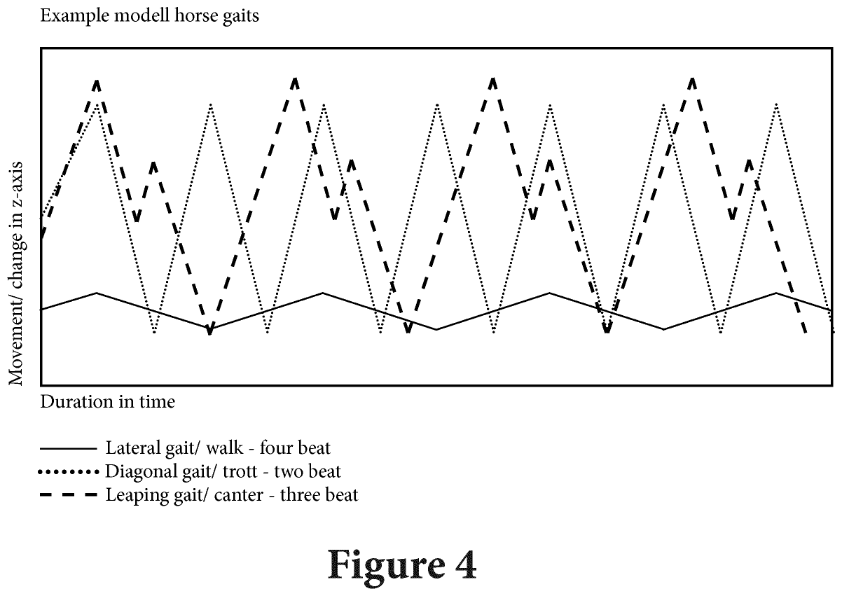

The loop shown in FIG. 3C relates to the identification of the horse's gait. The system may employ an algorithm which can distinguish between different gaits such as walking, trotting, cantering, tölt, and flying pace. This may be done by reading the movement pattern of the sequence of footfalls, time delay between each hoof stance/print, and the speed moving forward. The z-direction movement associated with lateral, diagonal and leaping gaits is shown in FIG. 4.

Very few horses have pure gaits, i.e. their movements are individual in the same way that each person's movement pattern is individual. So, the system is advantageously able to gather data to establish each individual horse's individual movement pattern in each gait and adjust the feedback settings accordingly. Each time the horse places a hoof in the ground this will instigate a movement through the horse's body that will be transmitted to the rider of the horse, who is wearing the system of the invention. The movement through the horse is correlated to the swing of the horses back and the horse's movement pattern in that gait/height of the stride in the gait. The resulting pattern in the data will be connected to a motion in the z-direction (i.e. height off the ground) and speed forward.

Model: identify the horse's footfall and speed, over a certain time period/duration which will give rise to a specific pattern of z-direction movement of the body part in question of a user.

Horses move forward in what is defined as their gaits. There are five different gates; walk, tölt (also called running walk), trot, canter and the flying pace, where walk, trot and canter usually are defined as the horse's “natural” gaits. The gaits are differentiated by the pattern of the horse's hoofs hitting the ground, i.e. which leg(s) hit the ground and in what order. The walk, tölt and flying pace are all lateral gaits where the horse moves the legs on the same side of the body, i.e. left hind, left front, right hind, right front. The number of hoofs on the ground will vary with the speed in the lateral gaits.

In the walk the horse has usually 3 hoofs on the ground in each stride, in the tölt the horse has 1 to 3 hoofs on the ground and in the flying pace 0 (the suspended part) to 2 hoofs on the ground. Each time the horse puts a hoof on the ground it will result in an indication that can be recognized in the z-axis.

Each gait produces a very specific pattern of movement. In the lateral gaits the horse's back does not swing very much in the z-axis with each stride and the pattern of the lateral gait on the z-axis is usually level with four indications per specific time period. The main difference between lateral gaits is the speed i.e. how fast the rider and horse moves forward. Walking speed is around 6.5 km h⁻¹, tölt up to 32 km h⁻¹, and the flying pace up to 48 km h⁻¹.

The lateral gaits are four beat gaits where the pace has a period of suspension.

The trot is a diagonal gait in which the horse moves its left hind leg and right front leg simultaneously followed by a period of suspension and then simultaneous movement of the right hind leg and the left front leg. This two-beat rhythm produce a recognizable two beat pattern that is distinguishable from the lateral gaits.

In the diagonal movement the horse's back swings a lot, a motion that often is hard for the rider to absorb. The average speed is around 13 km h⁻¹.

The canter is a three beat leaping gate with an average speed of 16 to 27 km h⁻¹.

It is easier for the rider to absorb the movements from the horse in the lateral gaits (the walk, tölt and pace) but in trot, and canter it is more difficult to absorb the horse's motions because the back swings more in the z-axis i.e. the tolerance of deviation from the optimal position needs to be adjusted accordingly and by doing this the system is improved and optimized.

The problem with the model is that in reality, horses often do not have clear gaits. A lateral gate is supposed to have an identical time between each footfall of the horse, but in reality this can vary. Similarly, the trot is supposed to have the same time in between the two occasions when the opposite legs hit the ground, and the two diagonal pairs of hoofs are supposed to hit the ground at the same time. In reality, the pairs may not hit the ground simultaneously. There may also be other variations. Each horse has its own “personal” movement pattern.

The present invention is such that by collecting data about the different gaits, the deviations from the clear gaits can be identified from the collected data from each horse movement pattern. By operating the loop as shown in FIG. 3C, the learning will label and identify each horse's unclear gaits more and more accurately with each use. The collective identified patterns of deviation can be classified and labelled and used to optimize the system for all users. In a similar manner this concept can be applied to other activities that include specific parameters that may have a range of varieties to be defined.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A wearable system for correction of body position, the system including:
a sensor, configured to detect a position of a user's body part or a movement pattern of a user's body part, and to transmit a signal corresponding to the detected position or detected movement pattern;
a processor, configured to receive the signal, and to determine a deviation of either the detected position from a predetermined optimal position, or the deviation of the detected movement pattern from a predetermined optimal movement pattern; and
a tactile feedback unit, configured to generate a tactile output in response to a determination that the detected position deviates from the optimal position or optimal movement pattern by equal to or more than a threshold deviation.

2. A wearable system according to claim 1, wherein the sensor is wearable, and includes an attachment means for attaching to the body part in question.

3. A wearable system according to claim 1 or claim 2, wherein the sensor is a position sensor, and is configured to detect the position of the body part in question based on its own position.

4. A wearable system according to any one of the preceding claims, wherein the sensor includes one or more of: a gyroscope, an accelerometer and a magnetometer.

5. A wearable system according to any one of the preceding claims, wherein the sensor is configured to continuously monitor the position or movement pattern of the body part in question.

6. A wearable system according to any one of the preceding claims, wherein the processor is configured to generate a deviation signal on determining that the detected position or movement pattern deviates from the optimal position or optimal movement pattern by equal to or more than the threshold deviation.

7. A wearable system according to any one of the preceding claims, wherein the processor is configured to transmit the deviation signal to the tactile feedback unit, and the tactile feedback unit is configured to receive the deviation signal.

8. A wearable system according to any one of the preceding claims, wherein the tactile feedback unit is configured to generate the tactile output in response to receiving the deviation signal.

9. A wearable system according to any one of the preceding claims, wherein the sensor, the processor and the tactile feedback unit are located within a single component.

10. A wearable system according to any one of the preceding claims, further including a garment, wherein one or more of the sensor, the processor, the single component and the tactile feedback unit is attached to the garment.

11. A wearable system according to any one of the preceding claims, wherein the garment is one of the following: trousers, a jacket, a shirt, shoes, shoe inlays or gloves.

12. A wearable system according to any one of the preceding claims, wherein the tactile feedback unit includes one or more vibrators, and wherein the tactile output of the tactile feedback unit is in the form of a vibration.

13. A wearable system according to any one of the preceding claims, wherein the nature of the tactile output varies with the extent of the deviation.

14. A wearable system according to any one of the preceding claims, wherein the tactile feedback unit is configured to provide the tactile output to locations in the body where the response is intuitive.

15. A wearable system according to any one of the preceding claims, wherein the tactile feedback unit is configured to provide the tactile output to one or more of: the base of the chin, the base of the back of the head, the area of chest covering the backbone, the front of the shoulder, between the shoulder blades, the outside of the elbow, above the waist, above the navel, or the inside of the hand.

16. A wearable system according to any one of the preceding claims, including a plurality of sensors and a corresponding plurality of tactile feedback units.

17. A wearable system according to any one of the preceding claims, wherein each of the plurality of sensors is configured to transmit a respective signal to a single processor, and the single processor is configured to transmit a deviation signal to each of the plurality of tactile feedback units.

18. A wearable system according to any one of the preceding claims, including a plurality of modules, each including a sensor and a tactile feedback located within the same housing.

19. A wearable system according to any one of the preceding claims, further including one or more pressure sensors or force sensors arranged to detect a pressure distribution or force distribution of the user over an area, and to transmit a pressure signal or force signal to the processor.

20. A wearable system according to any one of the preceding claims, wherein the processor is configured to determine the deviation signal based on the pressure signal or force signal and the signal corresponding to the detected position or detected movement pattern.

21. A wearable system according to claim 19 or claim 20, wherein the system includes a force sensor located between a stirrup and a stirrup leather.

22. A wearable system according to any one of the preceding claims, wherein the threshold deviation is adjustable by a user.

23. A wearable system according to any one of the preceding claims, wherein the system further includes a computer system configured to receive an input from a user.

24. A wearable system according to claim 23, wherein the computer system has loaded thereon an application configured to provide a user interface, the computer system configured to receive the input from the user via the user interface.

25. A wearable system according to claim 23 or claim 24, wherein the processor is located on or in the computer system.

26. A wearable system according to any one of the preceding claims, wherein the system further includes a memory, in which the system is configured to store position data and/or movement pattern data from the sensor or sensors.

27. A wearable system according to any one of the preceding claims, wherein the tactile feedback unit is configured to generate a tactile output only when it is determined that the user is performing a selected activity.

28. A wearable system according to claim 27, wherein the selected activity has associated with it an activity model, which defines the set of movements associated with that activity, and wherein the processor is configured to compare position data and/or movement pattern data from the sensors with the activity model in order to determine whether or not the position data and/or movement pattern data is consistent with the selected activity.

29. A wearable system according to claim 28, wherein the processor is also configured to update the activity model based on the data from the sensors.

30. A wearable system according to claim 28 or claim 29, wherein the activity model is stored on the memory.

31. A wearable system according to any one of the preceding claims, wherein the user is a horse rider, and the system is configured to identify the gait of the horse.

32. A method of correcting a user's body position, the method including the steps of:
detecting, by a sensor, the position of a body part of a user or the movement pattern of a body part of a user;
transmitting a signal corresponding to the detected position or movement pattern;
determining, by a processor, a deviation of the detected position or movement pattern from a predetermined optimal position or optimal movement pattern; and
generating, by a tactile feedback unit, a tactile output in response to a determination that the detected position or movement pattern deviates from the optimal position or optimal movement pattern by equal to or more than a threshold deviation.
